(19) United States
(12) Patent Application Publication
(10) Pub. No.: US 2019/0262765 A1
(43) Pub. Date: Aug. 29, 2019

(54) Apparatus and System for Swing Adsorption Processes

(71) Applicants: William Barnes, Spring, TX (US); Ananda K. Nagavarapu, Houston, TX (US)

(72) Inventors: William Barnes, Spring, TX (US); Ananda K. Nagavarapu, Houston, TX (US)

(21) Appl. No.: 16/258,266

(22) Filed: Jan. 25, 2019

Related U.S. Application Data
(60) Provisional application No. 62/636,442, filed on Feb. 28, 2018.

(51) Int. Cl. B01D 53/04; B01D 53/047

(52) U.S. Cl. CPC B01D 53/0446; B01D 53/0462; B01D 53/0473; B01D 2259/40009; B01D 2256/245; B01D 2259/40043; B01D 2257/702; B01D 2257/80; B01D 2259/40003; B01D 2259/40028; B01D 2257/504

(57) ABSTRACT

Provided are apparatus and systems for performing a swing adsorption process. This swing adsorption process may involve performing the swing adsorption process in a swing adsorption process skid. The process may be utilized for swing adsorption processes, such as TSA and/or PSA, which are utilized to remove one or more contaminants from a gaseous feed stream.

### CROSS-REFERENCE TO RELATED APPLICATION

This application claims the benefit of U.S. Provisional Patent Application 62/636,442 filed 28 Feb. 2018 entitled APPARATUS AND SYSTEM FOR SWING ADSORPTION PROCESSES, the entirety of which is incorporated by reference herein.

### FIELD

The present techniques relate to a method and system associated with swing adsorption processes used in conditioning streams for downstream processing. In particular, the method and system involves performing swing adsorption processes to dampen the temperature swing in the product stream to within acceptable limits for the downstream process.

### BACKGROUND

Gas separation is useful in many industries and can typically be accomplished by flowing a mixture of gases over an adsorbent material that preferentially adsorbs one or more gas components while not adsorbing one or more other gas components. The non-adsorbed components are recovered as a separate product.

One particular type of gas separation technology is swing adsorption, such as temperature swing adsorption (TSA), pressure swing adsorption (PSA), partial pressure swing adsorption (PPSA), rapid cycle temperature swing adsorption (RCTSA), rapid cycle pressure swing adsorption (RCPSA), rapid cycle partial pressure swing adsorption (RCPPSA), and not limited to but also combinations of the fore mentioned processes, such as pressure and temperature swing adsorption. As an example, PSA processes rely on the phenomenon of gases being more readily adsorbed within the pore structure or free volume of an adsorbent material when the gas is under pressure. That is, the higher the gas pressure, the greater the amount of readily-adsorbed gas adsorbed. When the pressure is reduced, the adsorbed component is released, or desorbed from the adsorbent material.

The swing adsorption processes (e.g., PSA and/or TSA) may be used to separate gases of a gas mixture because different gases tend to fill the micropore of the adsorbent material to different extents. For example, if a gas mixture, such as natural gas, is passed under pressure through a vessel containing an adsorbent material that is more selective towards carbon dioxide than it is for methane, at least a portion of the carbon dioxide is selectively adsorbed by the adsorbent material, and the gas exiting the vessel is enriched in methane. When the adsorbent material reaches the end of its capacity to adsorb carbon dioxide, it is regenerated by reducing the pressure, thereby releasing the adsorbed carbon dioxide. Then, the adsorbent material is typically purged and repressurized prior to starting another adsorption cycle.

The swing adsorption processes typically involve adsorbent bed units, which include adsorbent beds disposed within a housing and configured to maintain fluids at various pressures for different steps in a cycle within the unit. These adsorbent bed units utilize different packing material in the bed structures. For example, the adsorbent bed units utilize checker brick, pebble beds or other available packing. As an enhancement, some adsorbent bed units may utilize engineered packing within the bed structure. The engineered packing may include a material provided in a specific configuration, such as a honeycomb, ceramic forms or the like.

Further, various adsorbent bed units may be coupled together with conduits and valves to manage the flow of fluids through the cycle. Orchestrating these adsorbent bed units involves coordinating the steps in the cycle for each of the adsorbent bed units with other adsorbent bed units in the system. A complete cycle can vary from seconds to minutes as it transfers a plurality of gaseous streams through one or more of the adsorbent bed units.

A challenge with rapid cycle processes is remote locations and deployment for equipment to such locations. Conventional approaches focus on develop of designs that are optimized around a typical condition and rate it for operation at the desired condition. For example, an amine plant is designed around a typical feed acid gas content. Depending upon the actual content of CO₂ in the feed gas stream, adjustments are performed to the amine plant design, such as reduction in feed flow rate, add-on reboilers, etc.

Accordingly, there remains a need in the industry for apparatus, methods, and systems that provided enhancements to swing adsorption processes associated with hydrocarbon recovery processes. In particular, a need exists for enhancements to standardized configurations for rapid cycle swing adsorption processes.

### SUMMARY OF THE INVENTION

In one embodiment, a process for removing contaminants from a gaseous feed stream with a swing adsorption process is described. The process comprising: a) obtaining a standardized swing adsorption process skid; b) obtaining hydrocarbon processing data associated with a hydrocarbon processing application associated with a swing adsorption process; c) determining adjustments to the standardized swing adsorption process skid; d) configuring the standardized swing adsorption process skid based on the adjustments to obtain an adjusted standardized swing adsorption process skid; and e) processing a gaseous feed stream to remove contaminants from the gaseous feed stream to produce a product stream with the adjusted standardized swing adsorption process skid using a swing adsorption process.

In other embodiments, the process may include various enhancements. The enhancements may include deploying the adjusted standardized swing adsorption process skid to a location to perform the swing adsorption process on the gaseous feed stream; deploying the standardized swing adsorption process skid to a location; and configuring the standardized swing adsorption process skid at the location; monitoring the product stream of the swing adsorption process, passing the product stream to a downstream process if the product stream is within specification, and adjusting the swing adsorption process skid if the product stream is not within specification; wherein the downstream process is a liquefied natural gas (LNG) process that comprises an LNG process unit; wherein the standardized swing adsorption process skid comprises two or more swing adsorption bed units and a plurality of valves in each of the two or more swing adsorption bed units; wherein the determining adjustments to the standardized swing adsorption process skid comprises determining the adsorbent material for an adsorbent bed to be disposed within each of the two or more swing adsorption bed units; wherein configuring the standardized swing adsorption process skid comprises adjusting flow paths for one or more conduits coupled to each of the two or more swing adsorption bed units; wherein the swing adsorption process comprises: a) performing an adsorption step, wherein the adsorption step comprises passing the gaseous feed stream through an adsorbent bed unit to remove the contaminants and produce the product stream, b) interrupting the flow of the gaseous feed stream, c) performing a regeneration step, wherein the regeneration step comprises removing one or more of the contaminants from the adsorbent bed unit, and d) repeating the steps a) to c) for at least one additional cycle in the swing adsorption process; wherein the regeneration step comprises: performing a heating step, wherein the heating step comprises passing a heating stream through the adsorbent bed unit to remove one or more of the contaminants from the adsorbent bed unit, and performing a cooling step, wherein the cooling step comprises lessening the temperature of an adsorbent material in the adsorbent bed unit by passing a cooling stream through the adsorbent bed unit; wherein the swing adsorption process has a cycle duration is for a period greater than 1 second and less than 600 seconds; wherein the gaseous feed stream is a hydrocarbon containing stream having greater than one volume percent hydrocarbons based on the total volume of the feed stream; wherein the gaseous feed stream comprises hydrocarbons and CO₂, wherein the CO₂ content is in the range of two hundred parts per million volume and less than or equal to about 2% volume of the gaseous feed stream; wherein the swing adsorption process is configured to lower the carbon dioxide (CO₂) level to less than 50 parts per million; and/or wherein the swing adsorption process has a cycle duration that is greater than 2 seconds and less than 180 seconds.

### BRIEF DESCRIPTION OF THE FIGURES

The foregoing and other advantages of the present disclosure may become apparent upon reviewing the following detailed description and drawings of non-limiting examples of embodiments.

FIG. 1 is a three-dimensional diagram of the swing adsorption system with six adsorbent bed units and interconnecting piping in accordance with an embodiment of the present techniques.

FIG. 2 is a diagram of a portion of an adsorbent bed unit having associated valve assemblies and manifolds in accordance with an embodiment of the present techniques.

FIG. 3 is an exemplary flow chart for performing a swing adsorption process in accordance with an embodiment of the present techniques.

FIG. 4 is an exemplary diagram of a first standardized swing adsorption process skid in accordance with an embodiment of the present techniques.

FIG. 5 is an exemplary diagram of an embodiment of a second standardized swing adsorption process skid in accordance with an embodiment of the present techniques.

FIG. 6 is an exemplary diagram of an embodiment of a third standardized swing adsorption process skid in accordance with an embodiment of the present techniques.

FIG. 7 is an exemplary diagram of an embodiment of a fourth standardized swing adsorption process skid in accordance with an embodiment of the present techniques.

FIG. 8 is an exemplary diagram of an embodiment of a fifth standardized swing adsorption process skid in accordance with an embodiment of the present techniques.

FIG. 9 is an exemplary diagram of an embodiment of a sixth standardized swing adsorption process skid in accordance with an embodiment of the present techniques.

FIG. 10 is an exemplary diagram of an embodiment of a seventh standardized swing adsorption process skid in accordance with an embodiment of the present techniques.

### DETAILED DESCRIPTION OF THE INVENTION

Unless otherwise explained, all technical and scientific terms used herein have the same meaning as commonly understood by one of ordinary skill in the art to which this disclosure pertains. The singular terms “a,” “an,” and “the” include plural referents unless the context clearly indicates otherwise. Similarly, the word “or” is intended to include “and” unless the context clearly indicates otherwise. The term “includes” means “comprises.” All patents and publications mentioned herein are incorporated by reference in their entirety, unless otherwise indicated. In case of conflict as to the meaning of a term or phrase, the present specification, including explanations of terms, control. Directional terms, such as “upper,” “lower,” “top,” “bottom,” “front,” “back,” “vertical,” and “horizontal,” are used herein to express and clarify the relationship between various elements. It should be understood that such terms do not denote absolute orientation (e.g., a “vertical” component can become horizontal by rotating the device). The materials, methods, and examples recited herein are illustrative only and not intended to be limiting.

As used herein, “stream” refers to fluid (e.g., solids, liquid and/or gas) being conducted through various equipment. The equipment may include conduits, vessels, manifolds, units or other suitable devices.

As used herein, “conduit” refers to a tubular member forming a channel through which something is conveyed. The conduit may include one or more of a pipe, a manifold, a tube or the like.

The provided processes, apparatus, and systems of the present techniques may be used in swing adsorption processes that remove contaminants (CO₂, H₂O, and H₂S) from feed streams, such as hydrocarbon containing streams. As may be appreciated and as noted above, the hydrocarbon containing feed streams may have different compositions. For example, hydrocarbon feed streams vary widely in amount of acid gas, such as from several parts per million acid gas to 90 volume percent (vol. %) acid gas. Non-limiting examples of acid gas concentrations from exemplary gas reserves sources include concentrations of approximately: (a) 4 ppm H₂S, 2 vol. % CO₂, 100 ppm H₂O (b) 4 ppm H₂S, 0.5 vol. % CO₂, 200 ppm H₂O (c) 1 vol. % H₂S, 2 vol. % CO₂, 150 ppm H₂O, (d) 4 ppm H₂S, 2 vol. % CO₂, 500 ppm H₂O, and (e) 1 vol. % H₂S, 5 vol. % CO₂, 500 ppm H₂O. Further, in certain applications the hydrocarbon containing stream may include predominately hydrocarbons with specific amounts of CO₂ and/or water. For example, the hydrocarbon containing stream may have greater than 0.00005 volume percent CO₂ based on the total volume of the gaseous feed stream and less than 2 volume percent CO₂ based on the total volume of the gaseous feed stream; or less than 10 volume percent CO₂ based on the total volume of the gaseous feed stream. The processing of feed streams may be more problematic when certain specifications have to be satisfied.

The removal of contaminants may be performed by swing adsorption processes to prepare the stream for further downstream processing, such as NGL processing and/or LNG processing. For example, natural gas feed streams for liquefied natural gas (LNG) applications have stringent specifications on the CO₂ content to ensure against formation of solid CO₂ at cryogenic temperatures. The LNG specifications may involve the CO₂ content to be less than or equal to 50 ppm. Such specifications are not applied on natural gas streams in pipeline networks, which may involve the CO₂ content up to 2 vol. % based on the total volume of the gaseous feed stream. As such, for LNG facilities that use the pipeline gas (e.g., natural gas) as the raw feed, additional treating or processing steps are utilized to further purify the stream. Further, the present techniques may be used to lower the water content of the stream to less than 0.1 ppm. Exemplary swing adsorption processes and configurations may include U.S. Patent Application Publication Nos. US2017/0056814, US2017/0113175 and US2017/0113173, and U.S. Pat. Nos. 10,080,991, 10,124,286, 10,080,992 and 10,040,022, which are each incorporated by reference herein.

Conventional approaches for rapid cycle processes are custom designed for a particular application. This relies upon the fact that the gas compositions for two applications are different. The equipment used to process gas for each application is unique and different from each other. Each application requires elaborate engineering, and the corresponding fabrication, packaging, and construction costs are high (as these are one-off designs) and can be prohibitively expensive.

To provide enhancement in efficiencies, standardization of designs is a popular approach in the oil and gas industry (particularly in the gas processing area). Here a standard design may be adapted to operate for wide range of conditions. For example, the compromise is usually made on the throughput in a single train. Then, several parallel trains are used to provide the desired overall throughput. The standard swing adsorption equipment may remain the same, which results in reduced overall costs for engineering, procurement, fabrication and construction. The adjustments of these standard swing adsorption equipment for different rapid cycle processes provides cost efficiencies and timing efficiencies. This adaptability for the different swing adsorption cycles may be used to provide flexibility in the adsorption steps and regeneration steps that may be used to manage a wide range of inlet gas compositions.

In addition to the cost benefits, standardization also results in execution benefits. With a standard size of the rapid cycle systems, a skid based approach may be adopted. In this approach, skids of the process equipment may be fabricated in a low-cost environment shop and transported to the area of deployment, rather than the conventional approach where the equipment are fabricated near the area of deployment.

Accordingly, the present techniques provide configurations and processes that are utilized to enhance swing adsorption processes. As noted above, the remote locations and deployment concerns are problematic for hydrocarbon processes. The present techniques may utilize standardization of gas processing equipment to lessen costs, lessen project timelines, and simplify of deployment and execution strategy. Other approaches design configurations that develop standard designs that are optimized around a standard conditions and rate it for operation at the desired conditions. For example, a standard amine plant may be designed around a typical feed acid gas content. Depending upon the actual content of CO₂ in the feed stream, adjustments are made to the standard amine plant design, which may include a reduction in feed flow rate, add-on reboilers, and other such equipment. The present techniques may complete the vast majority of design for an amine plant in advance, which minimizes the timeline for deployment by directing the efforts and focus on variations. Additionally, the present techniques provide the functionality to form a kit associated with a standard configuration that may be mass produced, which further lowers costs of developing and producing these system. Another example may be standardized cryogenic NGL recovery plants, where add-in refrigeration modules provide the necessary refrigeration to increase recovery.

In one configuration, a swing adsorption process cycle may be configured to achieve a desired separation, which varies with the amount of contaminants in the feed stream. For example, for very low amount of CO₂ in the feed stream (e.g., about 100 to 500 parts per million volume (ppmv)), a single heated purge is sufficient to regenerate the adsorbent bed. However, as the CO₂ content increases, a double purge configuration may be preferred, where the purge stream from a cleaned adsorbent bed that may be used to provide heat to a spent adsorbent bed. As the feed CO₂ content increases further, a loop configuration may be required where heat for regeneration is provided by a self-contained loop. As such, it is apparent that the swing adsorption cycle configuration dramatically changes with the amount of CO₂ in the feed stream. Furthermore, the purge pressures and/or purge temperatures may also be changed substantially for each configuration.

To facilitate standardization of swing adsorption systems, the present techniques may standardize swing adsorption process equipment, such as adsorbent bed units and rapid cycle valves. The flow rates (e.g., throughput) through each systems may be configured to float, such that the CO₂ content in the feed stream may increase, and the flow rates may be decreased. By way of example, one configuration of the swing adsorption process skid may contains five adsorbent bed units. Each adsorbent bed unit may have six valves and associated plumbing (e.g., three on either side to facilitate flow of the feed, product and purge streams). The adsorbent structure inside the vessels may be fixed for each configuration and/or may be flexible for each configuration. As a result, an optimization to the standardized swing adsorption process skid may involve varying the adsorbent structure, such that the adsorbent structure still fits within the same vessel. By way of example, the adsorbent bed unit and rapid cycle valves may be standardized and the adsorbent bed may be a standard configuration to fit within the adsorbent bed unit, but may involve different adsorbent materials for specific applications. The adsorbent structure may be designed to be support different adsorbent beds, which composition being filtered. In such configuration, the adsorbent beds may be changed, designed, fabricated and built independent of the rest of the swing adsorption system.

In another configuration, the swing adsorption process skid may be used for very low amount of CO₂ in the feed stream. In this configuration, the system may operate by using three adsorbent beds in an adsorption step (e.g., passing a feed stream through the adsorbent beds) at a given time and one adsorbent bed performing a regeneration step. As a result, if one adsorbent bed was used to treat a first volume of feed stream, the swing adsorption process skid treats three times the first volume of the feed stream. The purge stream may be supplied at a purge temperature and/or purge pressure that may be sufficient to regenerate the adsorbent bed. An alternate configuration may involve two adsorbent beds being passed a feed stream and two adsorbent beds performing a regeneration step.

In yet another configuration, the swing adsorption process skid may be a double purge configuration that is utilized for intermediate amounts of CO₂ in the feed stream. In this configuration, two adsorbent beds may be performing an adsorption step (e.g., receiving a feed stream), one adsorbent bed may be performing a cleaning purge step and one adsorbent bed may be performing a heating purge step. The stream coming from the adsorbent bed during the cleaning purge step is passed to a heating unit (e.g., heater) before being passed to another adsorbent bed during the heating step (e.g., heating purge step). The heating unit may be an add-on to the standard swing adsorption process skid and is usually custom designed. This configuration may be processed at two times the feed stream. As the CO₂ content in the feed stream increases, the purge pressure may be lowered to sufficiently regenerate the adsorbent bed. The valves may be designed to be oversized for some configurations.

In still yet another configuration, the swing adsorption process skid may be utilized for intermediate amounts of CO₂ in the feed stream. As the CO₂ content in the feed stream is further increased, a loop configuration may be used to manage the CO₂ content. The process gas may be looped around to provide the necessary heat to facilitate regeneration during the regeneration step, while a cleaning purge step may be used to remove the contaminants from a spent adsorbent bed. The loop may be circulated with a small low-head compressor, such as molecular sieve blower, and heat may be supplied by a heating unit (e.g., heater), both of which may be designed outside the standard swing adsorption process skid as add-ons. This configuration may include two adsorbent bed units that are performing adsorption steps, one of the adsorbent bed units may be looping a heating stream (e.g., during a heating step) and one adsorbent bed unit performing a purge step on a purge stream. As the CO₂ content in the feed stream increases, the purge pressure may be lowered to sufficiently regenerate the adsorbent bed. By way of example, the ranges are described in U.S. Patent Application Publication Nos. US2017/0056814 and U.S. Pat. Nos. 10,080,991 and 10,124,286, which are each incorporated by reference.

In an additional configuration, the swing adsorption process skid may be utilized for higher levels of CO₂ content in the feed stream. As the CO₂ in the feed stream increases, a different loop configuration may be utilized. The configuration, may include two adsorbent beds performing an adsorption step (e.g., treating the feed stream), a single adsorbent bed unit may be on feed stream, while two adsorbent bed units are on loop being heated during a heating step. The loop is circulated with a larger low-head compressor (such as molecular sieve blower) and heat is supplied by a heater, both of which may be configured to perform operations outside the standard swing adsorption process as add-ons. The low-head compressor is outside the standard kit but is often procured as a standard piece of equipment. As the CO₂ content in the feed stream increases, the purge pressure may be lowered to sufficiently regenerate the adsorbent bed.

In yet another configuration, the swing adsorption process skid may be adopted to provide swing adsorption cycles to remove other contaminants. For dehydration applications, the amount of contaminants may be removed is capped by the saturation conditions of the gas. As such, different sets of cycle configurations may not be necessary. However, a similar approach may be adopted to increase throughput. For example, the swing adsorption process skid may have a spare adsorbent bed unit installed, which is usually not operational during normal operation. However, if additional throughput is required, the spare adsorbent bed may be brought into operation with the other adsorbent bed units. An example, the swing adsorption process skid is shown for dehydration of cryogenic NGL feed.

In certain configurations, a swing adsorption system to minimize the temperature and compositional swing in a stream leaving a rapid cycle pressure and temperature swing adsorption process.

The present techniques may be a swing adsorption process, and specifically a rapid cycle adsorption process. The present techniques may include some additional equipment, such as one or more conduits and/or one or more manifolds that provide a fluid path for the cooling step and/or dampening system. In addition, other components and configurations may be utilized to provide the swing adsorption process, such as rapid cycle enabling hardware components (e.g., parallel channel adsorbent bed designs, rapid actuating valves, adsorbent bed configurations that integrate with other processes). Exemplary swing adsorption processes and configurations may include U.S. Patent Application Publication Nos. US2017/0056814, US2017/0113175 and US2017/0113173, and U.S. Pat. Nos. 10,080,991, 10,124,286, 10,080,992 and 10,040,022, which are each incorporated by reference herein.

In one or more configurations, a swing adsorption process may include performing various steps. For the example, the present techniques may be used to remove contaminants from a gaseous feed stream with a swing adsorption process, which may be utilized with one or more downstream processes. The process comprising: a) performing a regeneration step (e.g., purge step), wherein the step comprises passing purge stream through an adsorbent bed unit to remove contaminants from an adsorbent bed within a housing of the adsorbent bed unit to form a purge product stream, which may be a heated purge stream; b) performing one or more adsorption steps, wherein each of the one or more adsorption steps comprise passing a gaseous feed stream through an adsorbent bed unit having an adsorbent bed to separate contaminants from the gaseous feed stream to form a product stream. In addition, the method may include determining whether the product stream and/or purge stream is within a temperature specification and/or composition specification. In other configurations, the method may involve monitoring the feed stream and if the feed stream is within the respective specification (e.g., is below a certain threshold), passing the feed stream to the swing adsorption system and if the feed stream is not within the specification (e.g., above a certain threshold), adjusting the adsorption swing process to compensate for the additional contaminants.

In other certain embodiments, the swing adsorption process may be integrated with downstream equipment and processes. The downstream equipment and processes may include control freeze zone (CFZ) applications, niotrogen removal unit (NRU), cryogenic NGL recovery applications, LNG applications, and other such applications. Each of these different applications may include different specifications for the feed stream in the respective process. For example, a cryogenic NGL process or an LNG process and may be integrated with the respective downstream equipment. As another example, the process may involve H₂O and/or CO₂ removal upstream of a cryogenic NGL process or the LNG process and may be integrated with respective downstream equipment.

In certain configurations, the system utilizes a combined swing adsorption process, which combines TSA and PSA, for treating of pipeline quality natural gas to remove contaminants for the stream to satisfy LNG specifications. The swing adsorption process, which may be a rapid cycle process, is used to treat natural gas that is at pipeline specifications (e.g., a feed stream of predominately hydrocarbons along with less than or equal to about 2% volume CO₂ and/or less than or equal to 4 ppm H₂S) to form a stream satisfying the LNG specifications (e.g., less than 50 ppm CO₂ and less than about 4 ppm H₂S). The product stream, which may be the LNG feed stream, may have greater than 98 volume percent hydrocarbons based on the total volume of the product stream, while the CO₂ and water content are below certain thresholds. The LNG specifications and cryogenic NGL specifications may involve the CO₂ content to be less than or equal to 50 ppm, while the water content of the stream may be less than 0.1 ppm.

Moreover, the present techniques may include a specific process flow to remove contaminants, such as CO₂ and/or water. For example, the process may include an adsorbent step and a regeneration step, which form the cycle. The adsorbent step may include passing a gaseous feed stream at a feed pressure and feed temperature through an adsorbent bed unit to separate one or more contaminants from the gaseous feed stream to form a product stream. The feed stream may be passed through the adsorbent bed in a forward direction (e.g., from the feed end of the adsorbent bed to the product end of the adsorbent bed). Then, the flow of the gaseous feed stream may be interrupted for a regeneration step. The regeneration step may include one or more depressurization steps, one or more heating steps, and/or one or more purge steps. The depressurization steps, which may be or include a blowdown step, may include reducing the pressure of the adsorbent bed unit by a predetermined amount for each successive depressurization step, which may be a single step and/or multiple steps. The depressurization step may be provided in a forward direction or may preferably be provided in a countercurrent direction (e.g., from the product end of the adsorbent bed to the feed end of the adsorbent bed). The heating step may include passing a heating stream into the adsorbent bed unit, which may be a recycled stream through the heating loop and is used to heat the adsorbent material. The purge step may include passing a purge stream into the adsorbent bed unit, which may be a once through purge step and the purge stream may be provided in countercurrent flow relative to the feed stream. The purge stream may be provided at a purge temperature and purge pressure, which may include the purge temperature and purge pressure being similar to the heating temperature and heating pressure used in the heating step. Then, the cycle may be repeated for additional streams. Additionally, the process may include one or more re-pressurization steps after the purge step and prior to the adsorption step. The one or more re-pressurization steps may be performed, wherein the pressure within the adsorbent bed unit is increased with each re-pressurization step by a predetermined amount with each successive re-pressurization step. The cycle duration may be for a period greater than 1 second and less than 600 seconds, for a period greater than 2 second and less than 300 seconds, for a period greater than 2 second and less than 180 seconds, for a period greater than 5 second and less than 150 seconds or for a period greater than 5 second and less than 90 seconds.

In one or more embodiments, the present techniques can be used for any type of swing adsorption process. Non-limiting swing adsorption processes for which the present techniques may be used include pressure swing adsorption (PSA), vacuum pressure swing adsorption (VPSA), temperature swing adsorption (TSA), partial pressure swing adsorption (PPSA), rapid cycle pressure swing adsorption (RCPSA), rapid cycle thermal swing adsorption (RCTSA), rapid cycle partial pressure swing adsorption (RCPPSA), as well as combinations of these processes. For example, the preferred swing adsorption process may include a combined pressure swing adsorption and temperature swing adsorption, which may be performed as a rapid cycle process. Exemplary swing adsorption processes and configurations may include U.S. Patent Application Publication Nos. US2017/0056814, US2017/0113175 and US2017/0113173, and U.S. Pat. Nos. 10,080,991, 10,124,286, 10,080,992, 10,040,022, 7,959,720, 8,545,602, 8,529,663, 8,444,750, 8,529,662 and 9,358,493, which are each herein incorporated by reference in their entirety.

Further still, in one or more configurations, a variety of adsorbent materials may be used to provide the mechanism for the separations. Examples include zeolite 3A, 4A, 5A, ZK4 and MOF-74. However, the process is not limited to these adsorbent materials, and others may be used as well.

In one configuration, a process for removing contaminants from a gaseous feed stream with a swing adsorption process is described. The process comprising: a) obtaining a standardized swing adsorption process skid; b) obtaining hydrocarbon processing data associated with a hydrocarbon processing application; c) determining adjustments to the standardized swing adsorption process skid; d) configuring the standardized swing adsorption process skid based on the adjustments; and e) processing a gaseous feed stream to remove contaminants from the gaseous feed stream to produce a product stream with the adjusted standardized swing adsorption process skid using a swing adsorption process.

In other configurations, the process may include various enhancements. The enhancements may include deploying the adjusted standardized swing adsorption process skid to a location to perform the swing adsorption process on the gaseous feed stream; deploying the standardized swing adsorption process skid to a location; and configuring the standardized swing adsorption process skid at the location; monitoring the product stream of the swing adsorption process, passing the product stream to a downstream process if the product stream is within specification, and adjusting the swing adsorption process skid if the product stream is not within specification; wherein the downstream process is a liquefied natural gas (LNG) process that comprises an LNG process unit; wherein the standardized swing adsorption process skid comprises two or more swing adsorption bed units and a plurality of valves in each of the two or more swing adsorption bed units; wherein the determining adjustments to the standardized swing adsorption process skid comprises determining the adsorbent material for an adsorbent bed to be disposed within each of the two or more swing adsorption bed units; wherein configuring the standardized swing adsorption process skid comprises adjusting flow paths for one or more conduits coupled to each of the two or more swing adsorption bed units; wherein the swing adsorption process comprises: a) performing an adsorption step, wherein the adsorption step comprises passing the gaseous feed stream through an adsorbent bed unit to remove the contaminants and produce the product stream, b) interrupting the flow of the gaseous feed stream, c) performing a regeneration step, wherein the regeneration step comprises removing one or more of the contaminants from the adsorbent bed unit, and d) repeating the steps a) to c) for at least one additional cycle in the swing adsorption process; wherein the regeneration step comprises: performing a heating step, wherein the heating step comprises passing a heating stream through the adsorbent bed unit to remove one or more of the contaminants from the adsorbent bed unit, and performing a cooling step, wherein the cooling step comprises lessening the temperature of an adsorbent material in the adsorbent bed unit by passing a cooling stream through the adsorbent bed unit; wherein the swing adsorption process has a cycle duration is for a period greater than 1 second and less than 600 seconds; wherein the gaseous feed stream is a hydrocarbon containing stream having greater than one volume percent hydrocarbons based on the total volume of the feed stream; wherein the gaseous feed stream comprises hydrocarbons and CO₂, wherein the CO₂ content is in the range of two hundred parts per million volume and less than or equal to about 2% volume of the gaseous feed stream; wherein the swing adsorption process is configured to lower the carbon dioxide (CO₂) level to less than 50 parts per million; and/or wherein the swing adsorption process has a cycle duration that is greater than 2 seconds and less than 180 seconds.

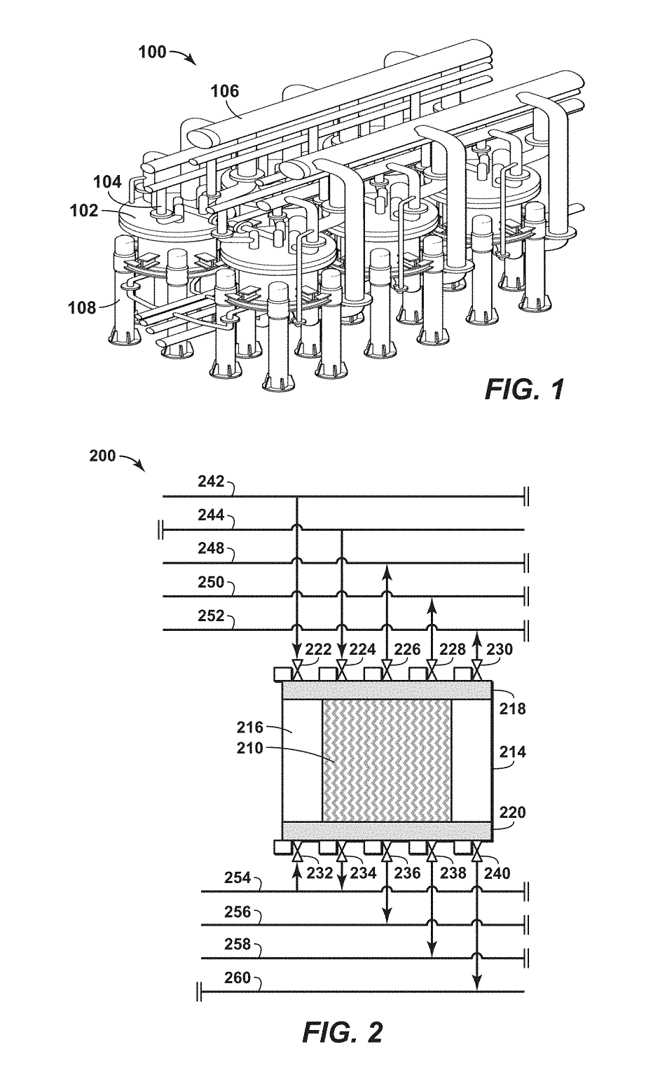

In yet another configuration, a swing adsorption system fabricated based on a standardized swing adsorption process skid is described. The present techniques may be further understood with reference to the FIGS. 1 to 10 below.

FIG. 1 is a three-dimensional diagram of the swing adsorption system 100 having six adsorbent bed units and interconnecting piping. While this configuration is a specific example, the present techniques broadly relate to adsorbent bed units that can be deployed in a symmetrical orientation, or non-symmetrical orientation and/or combination of a plurality of hardware skids. Further, this specific configuration is for exemplary purposes as other configurations may include different numbers of adsorbent bed units.

In this system, the adsorbent bed units, such as adsorbent bed unit 102, may be configured for a cyclical swing adsorption process for removing contaminants from feed streams (e.g., fluids, gaseous or liquids). For example, the adsorbent bed unit 102 may include various conduits (e.g., conduit 104) for managing the flow of fluids through, to or from the adsorbent bed within the adsorbent bed unit 102. These conduits from the adsorbent bed units 102 may be coupled to a manifold (e.g., manifold 106) to distribute the flow to, from or between components. The adsorbent bed within an adsorbent bed unit may separate one or more contaminants from the feed stream to form a product stream. As may be appreciated, the adsorbent bed units may include other conduits to control other fluid steams as part of the process, such as purge streams, depressurizations streams, and the like. In particular, the adsorbent bed units may include startup mode equipment, such as one or more heating units (not shown), one or more external gas source manifolds, which may be one of the manifolds 106) and one or more expanders, as noted further below, which is used as part of the startup mode for the adsorbent beds. Further, the adsorbent bed unit may also include one or more equalization vessels, such as equalization vessel 108, which are dedicated to the adsorbent bed unit and may be dedicated to one or more step in the swing adsorption process. The equalization vessel 108 may be used to store the external stream, such as nitrogen for use in the startup mode cycle.

As an example, which is discussed further below in FIG. 2, the adsorbent bed unit 102 may include a housing, which may include a head portion and other body portions, that forms a substantially gas impermeable partition, an adsorbent bed disposed within the housing and a plurality of valves (e.g., poppet valves) providing fluid flow passages through openings in the housing between the interior region of the housing and locations external to the interior region of the housing. Each of the poppet valves may include a disk element that is seatable within the head or a disk element that is seatable within a separate valve seat inserted within the head (not shown). The configuration of the poppet valves may be any variety of valve patterns or configuration of types of poppet valves. As an example, the adsorbent bed unit may include one or more poppet valves, each in flow communication with a different conduit associated with different streams. The poppet valves may provide fluid communication between the adsorbent bed and one of the respective conduits, manifolds or headers. The term “in direct flow communication” or “in direct fluid communication” means in direct flow communication without intervening valves or other closure means for obstructing flow. As may be appreciated, other variations may also be envisioned within the scope of the present techniques.

The adsorbent bed comprises a solid adsorbent material capable of adsorbing one or more components from the feed stream. Such solid adsorbent materials are selected to be durable against the physical and chemical conditions within the adsorbent bed unit 102 and can include metallic, ceramic, or other materials, depending on the adsorption process. Further examples of adsorbent materials are noted further below.

FIG. 2 is a diagram of a portion of an adsorbent bed unit 200 having valve assemblies and manifolds in accordance with an embodiment of the present techniques. The portion of the adsorbent bed unit 200, which may be a portion of the adsorbent bed unit 102 of FIG. 1, includes a housing or body, which may include a cylindrical wall 214 and cylindrical insulation layer 216 along with an upper head 218 and a lower head 220. An adsorbent bed 210 is disposed between an upper head 218 and a lower head 220 and the insulation layer 216, resulting in an upper open zone, and lower open zone, which open zones are comprised substantially of open flow path volume. Such open flow path volume in adsorbent bed unit contains gas that has to be managed for the various steps. The housing may be configured to maintain a pressure from 0 bara (bar absolute) to 150 bara within the interior region.

The upper head 218 and lower head 220 contain openings in which valve structures can be inserted, such as valve assemblies 222 to 240 (i.e., 222, 224, 226, 228, 230, 232, 234, 236, 238 and 240), respectively (e.g., poppet valves). The upper or lower open flow path volume between the respective head 218 or 220 and adsorbent bed 210 can also contain distribution lines (not shown) which directly introduce fluids into the adsorbent bed 210. The upper head 218 contains various openings (not show) to provide flow passages through the inlet manifolds 242 and 244 and the outlet manifolds 248, 250 and 252, while the lower head 220 contains various openings (not shown) to provide flow passages through the inlet manifold 254 and the outlet manifolds 256, 258 and 260. Disposed in fluid communication with the respective manifolds 242 to 260 are the valve assemblies 222 to 240. If the valve assemblies 222 to 240 are poppet valves, each may include a disk element connected to a stem element which can be positioned within a bushing or valve guide. The stem element may be connected to an actuating means, such as actuating means (not shown), which is configured to have the respective valve impart linear motion to the respective stem. As may be appreciated, the actuating means may be operated independently for different steps in the process to activate a single valve or a single actuating means may be utilized to control two or more valves. Further, while the openings may be substantially similar in size, the openings and inlet valves for inlet manifolds may have a smaller diameter than those for outlet manifolds, given that the gas volumes passing through the inlets may tend to be lower than product volumes passing through the outlets.

In swing adsorption processes, the cycle involves two or more steps that each has a certain time interval, which are summed together to be the cycle time or cycle duration. These steps include regeneration of the adsorbent bed following the adsorption step using a variety of methods including pressure swing, vacuum swing, temperature swing, purging (via any suitable type of purge fluid for the process), and combinations thereof. As an example, a PSA cycle may include the steps of adsorption, depressurization, purging, and re-pressurization. When performing the separation at high pressure, depressurization and re-pressurization (which may be referred to as equalization) may be performed in multiple steps to reduce the pressure change for each step and enhance efficiency. In some swing adsorption processes, such as rapid cycle swing adsorption processes, a substantial portion of the total cycle time is involved in the regeneration of the adsorbent bed. Accordingly, any reductions in the amount of time for regeneration results in a reduction of the total cycle time. This reduction may also reduce the overall size of the swing adsorption system.

Further, one or more of the manifolds and associated valves may be utilized as a dedicated flow path for one or more streams. For example, during the adsorption or feed step, the manifold 242 and valve assembly 222 may be utilized to pass the feed gas stream to the adsorbent bed 210, while the valve assembly 236 and manifold 256 may be used to conduct away the product stream from the adsorbent bed 210. During the regeneration or purge step, the manifold 244 and valve assembly 224 may be utilized to pass the purge or heating stream to the adsorbent bed 210, while the valve assembly 236 and manifold 256 may be used to conduct away the purge product stream from the adsorbent bed 210. As may be appreciated, the purge stream may be configured to flow counter current to the feed stream in certain embodiments.

Alternatively, the swing adsorption process may involve sharing one or more of the manifolds and associated valves. Beneficially, this configuration may be utilized to lessen any additional valves or connections for startup mode for adsorbent bed unit configurations that are subject to space limitations on the respective heads.

As noted above, the present techniques include a standardized swing adsorption process skid. The present techniques may include additional equipment associated with the transition of streams within the adsorbent bed units between the steps in the cycle.

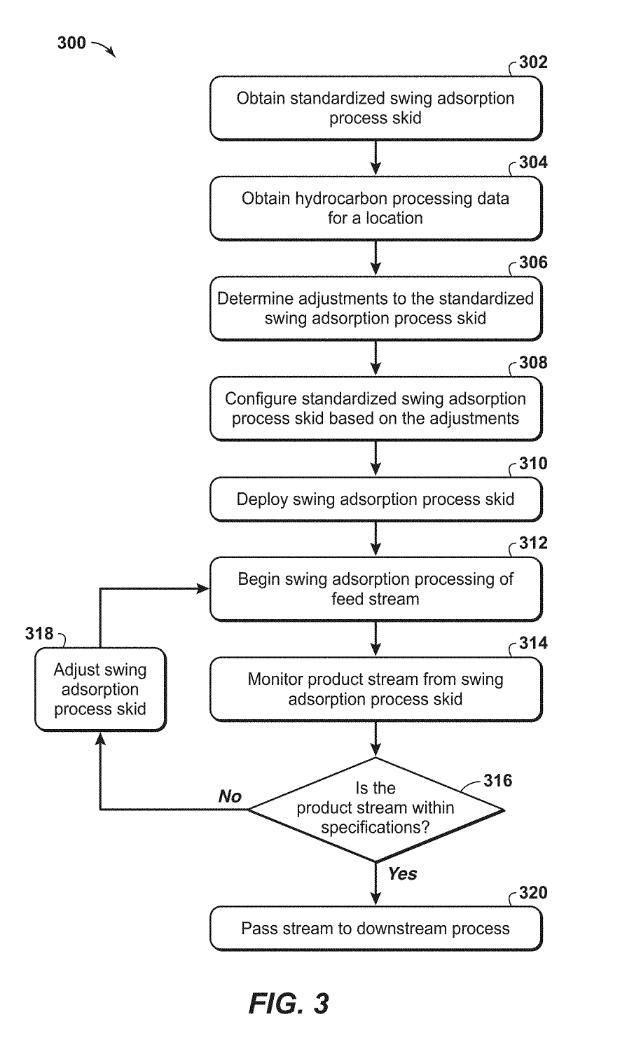

As an example, FIG. 3 is an exemplary flow chart for deploying and performing a swing adsorption process in accordance with an embodiment of the present techniques. In this flow chart 300, the swing adsorption process may remove one or more contaminants and may be adjusted to manage the one or more streams in the rapid cycle swing adsorption process units. The swing adsorption process may involve performing various steps to create and deploy a swing adsorption process skid, as shown in blocks 302 to 310 (i.e., 302, 304, 306, 308 and 310). Then, the swing adsorption process skid may be used to process the feed stream to produce a product stream and used for downstream equipment, as shown in blocks 312 to 320 (i.e., 312, 314, 316, 318, and 320).

The swing adsorption process may involve performing various steps to create and deploy a swing adsorption process skid, as shown in blocks 302 to 310. At block 302, standardized swing adsorption process skid is obtained. At block 304, hydrocarbon processing data for a location is obtained. The hydrocarbon processing data may include the composition of the feed stream and the one or more contaminants to be removed from the gaseous feed stream. At block 306, adjustments to the standardized swing adsorption process skid are determined. The adjustments may include changes to conduits to provide the desired flow rates, addition of equipment to heat or cool the streams, and the like. Then, the standardized swing adsorption process skid is configured based on the adjustments, as shown in block 308. At block 310, the swing adsorption process skid is deployed. The deployment of the swing adsorption process skid may include transporting the swing adsorption process skid to the location, which may be a remote location, and installing the swing adsorption process skid at the location for use with the downstream process.

After being deployed, the swing adsorption process skid may be used to process streams and to pass the product streams to downstream equipment, as shown in blocks 312 to 320. At block 312, the swing adsorption processing may begin by passing the feed stream through the swing adsorption process skid. At block 314, the product stream from swing adsorption process skid is monitored. The product stream may be monitored by a temperature sensor and/or a gas chromatograph or using another gas component analysis equipment. The product stream may also be measured by taking samples, using a moisture analyzer. Then, at block 316, a determination may be made whether the product stream is within the respective specification. The determination may include analyzing the product stream to determine the level of one or more of the temperature, pressure, composition and any combination thereof. If the product stream is within specification (e.g., contaminants are at or below a specific threshold), the product stream may be passed to downstream process, as shown in block 320. However, if the product stream is not within specifications, the swing adsorption process skid may be adjusted, as shown in block 318. Then, the process may begin processing the feed stream, as shown in block 312. The adjustment of the swing adsorption process skid may include changing the adsorbent bed, adjusting the flow rates or adjusting the conduits to provide additional steps in the swing adsorption process.

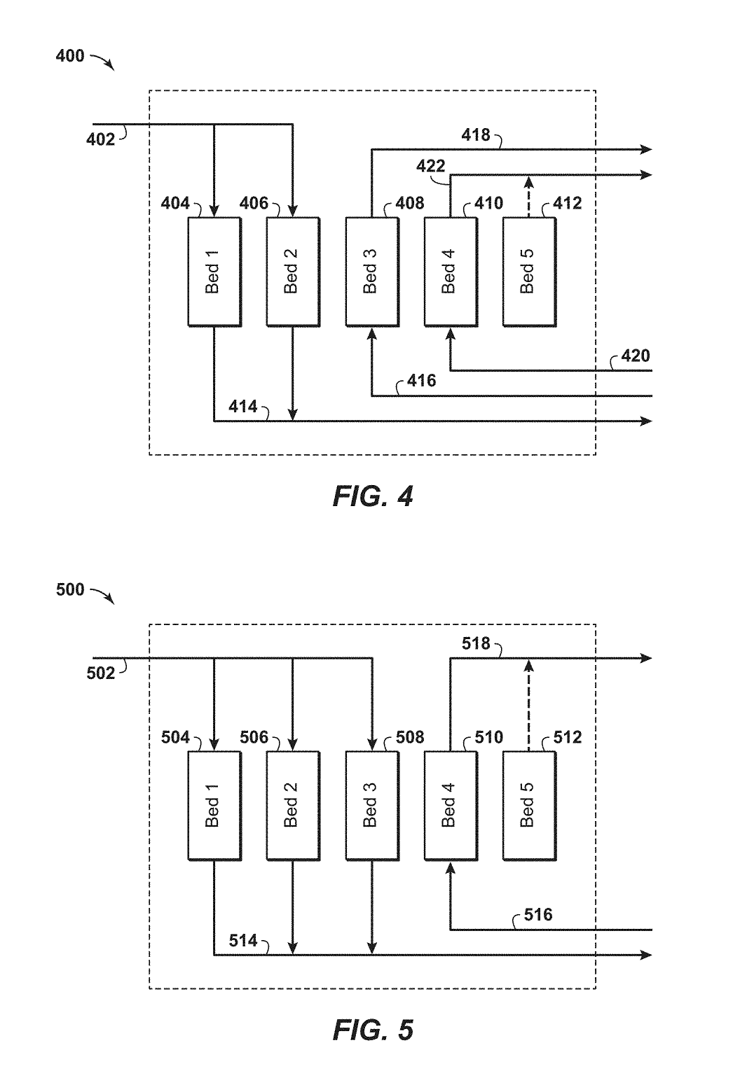

By way of example, the present techniques may include different configurations of the swing adsorption process skid. In particular, the present techniques may include various configurations, which is shown in FIGS. 4 to 10.

FIG. 4 is an exemplary diagram of an embodiment of a first standardized swing adsorption process skid 400 in accordance with an embodiment of the present techniques. The standardized swing adsorption process skid 400 may include five adsorbent bed units 404, 406, 408, 410 and 412. The first adsorbent bed unit 404 and a second adsorbent bed unit 406 are performing an adsorption step, while the third adsorbent bed unit 408 is performing a cleaning purge step, the fourth adsorbent bed unit 410 is performing a heating step and fifth adsorbent bed unit 412 is performing a blow-down step. The feed stream is passed through a feed conduit 402 to a first adsorbent bed unit 404 and a second adsorbent bed unit 406, while the resulting product stream is conducted away from the first adsorbent bed unit 404 and the second adsorbent bed unit 406 via a product conduit 414. A purge stream is passed through a purge conduit 416 to the third adsorbent bed unit 408, while the resulting purge product stream is conducted away from the third adsorbent bed unit 408 via a purge product conduit 418 to a purge vent. A heating stream is passed through a heating conduit 420 to the fourth adsorbent bed unit 410, while the resulting heating product stream is conducted away from the fourth adsorbent bed unit 410 via a heating purge product conduit 422 to a heating purge vent. In addition, the blow-down product stream is conducted away from the fifth adsorbent bed unit 412 via the heating purge product conduit 422 to the heating purge vent.

In this exemplary configuration, each of the adsorbent bed units has six valves and associated plumbing (e.g., three on either side to facilitate flow of the feed, product and purge streams). For simplicity, in this example the adsorbent structure inside the adsorbent bed unit are assumed to be fixed for each configuration. A further optimization may involve varying the adsorbent structure, such that they still fit in the same adsorbent bed unit.

FIG. 5 is an exemplary diagram of an embodiment of a second standardized swing adsorption process skid 500 in accordance with an embodiment of the present techniques. This configuration may be used for very low amount of CO₂ in the feed stream. The standardized swing adsorption process skid 500 may include five adsorbent bed units 504, 506, 508, 510 and 512. The first adsorbent bed unit 504, a second adsorbent bed unit 506 and a third adsorbent bed unit 508 are performing an adsorption step, while the fourth adsorbent bed unit 510 is performing a cleaning purge step and a fifth adsorbent bed unit 512 is performing a blow-down step. The feed stream is passed through a feed conduit 502 to the adsorbent bed units 504, 506 and 508, and the resulting product stream is conducted away from the adsorbent bed units 504, 506 and 508 via a product conduit 514. A purge stream is passed through a purge conduit 516 to the fourth adsorbent bed unit 510, while the resulting purge product stream is conducted away from the fourth adsorbent bed unit 510 via a purge product conduit 518 to a purge vent. A blow-down product stream is conducted away from the fifth adsorbent bed unit 512 via the heating purge product conduit 518 to the purge vent.

In this configuration, three adsorbent bed units 504, 506 and 508 are performing the adsorption step at a given time and one adsorbent bed unit 510 is performing a regeneration step. As such, if one adsorbent bed unit was used to treat X Mscfd of feed gas (e.g., X is the normalized feed gas flow rate), the swing adsorption process skid 500 treats 3×Mscfd of feed gas. The purge stream is supplied at a temperature and pressure that can sufficiently regenerate the adsorbent bed unit. An alternate configuration may provide that two adsorbent bed units are processing the feed stream and two adsorbent bed units are performing regeneration. In one example, this configuration may process up to 500 parts per million volume (ppmv) of CO₂, with the purge pressure varying from about 60 bar to about 5 bar.

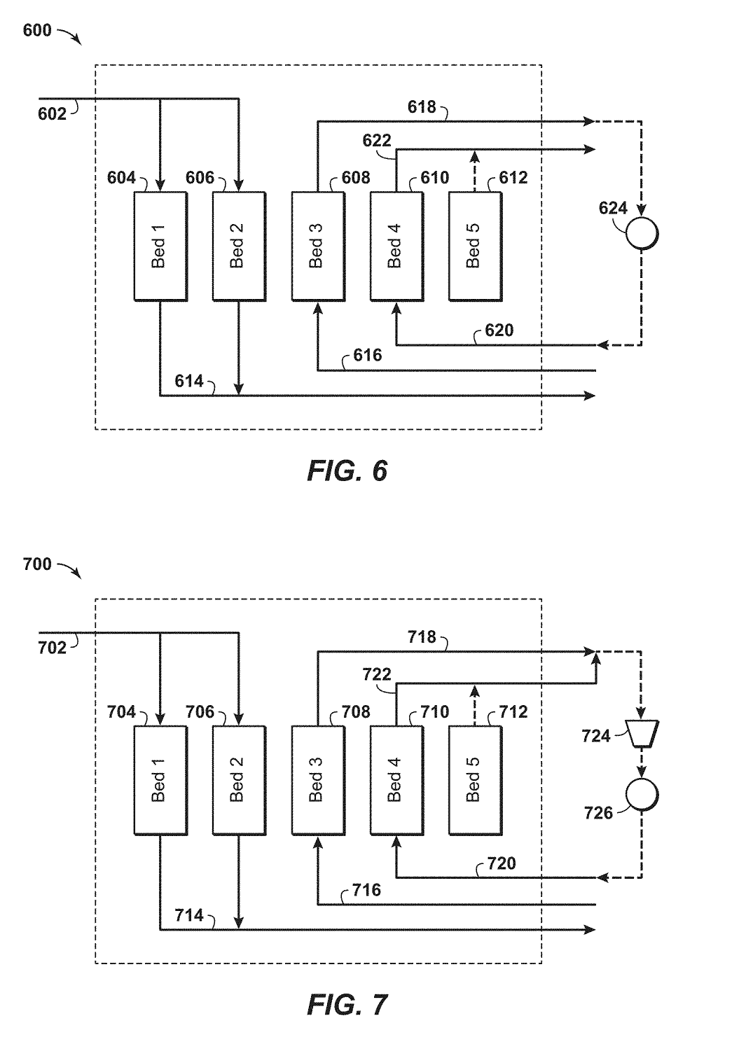

FIG. 6 is an exemplary diagram of an embodiment of a third standardized swing adsorption process skid 600 in accordance with an embodiment of the present techniques. This configuration may be used for intermediate amounts of CO₂ in the feed stream. This configuration involves a double purge configuration, which is a revised piping to manage a different gas composition of the feed stream. The standardized swing adsorption process skid 600 may include five adsorbent bed units 604, 606, 608, 610 and 612. The first adsorbent bed unit 604 and a second adsorbent bed unit 606 are performing an adsorption step, while the third adsorbent bed unit 608 is performing a cleaning purge step, the fourth adsorbent bed unit 610 is performing a heating step and fifth adsorbent bed unit 612 is performing a blow-down step. The feed stream is passed through a feed conduit 602 to a first adsorbent bed unit 604 and a second adsorbent bed unit 606, while the resulting product stream is conducted away from the first adsorbent bed unit 604 and the second adsorbent bed unit 606 via a product conduit 614. A purge stream is passed through a purge conduit 616 to the third adsorbent bed unit 608, while the resulting purge product stream is conducted away from the third adsorbent bed unit 608 via a purge product conduit 618. The purge product stream is passed from the purge product stream to a heating unit 624 to create a heating stream and then is passed through a heating conduit 620 to the fourth adsorbent bed unit 610, while the resulting heating product stream is conducted away from the fourth adsorbent bed unit 610 via a heating purge product conduit 622 to a purge vent. In addition, the blow-down product stream is conducted away from the fifth adsorbent bed unit 612 via the heating purge product conduit 622 to the purge vent.

In this configuration, the purge product stream conducted away from adsorbent bed unit 608 during the cleaning purge is continued to the heating unit 624 before being introduced back into the adsorbent bed unit 610 to complete the heating purge. The heating unit 624 may be an add-on to the standard swing adsorption process skid and may be customized by the conduits indicated by the dashed lines. This configuration may process 2×Mscfd of gas in the adsorbent bed units 604 and 606. As the CO₂ content in the feed stream increases, the purge pressure may be lowered to sufficiently regenerate the adsorbent bed unit. In one example, this configuration may process up to 3,000 ppmv of CO₂, with the purge pressure varying from about 60 bar to about 5 bar. The valves may be designed to be oversized for some configurations.

FIG. 7 is an exemplary diagram 700 of an embodiment of a fourth standardized swing adsorption process skid in accordance with an embodiment of the present techniques. This configuration may be used for intermediate amounts of CO₂ in the feed stream. In particular, as the CO₂ in the feed stream further increases, a loop configuration can be adopted, which modifies the double purge configuration. The standardized swing adsorption process skid 700 may include five adsorbent bed units 704, 706, 708, 710 and 712. The first adsorbent bed unit 704 and a second adsorbent bed unit 706 are performing an adsorption step, while the third adsorbent bed unit 708 is performing a cleaning purge step, the fourth adsorbent bed unit 710 is performing a heating step and fifth adsorbent bed unit 712 is performing a blow-down step. The feed stream is passed through a feed conduit 702 to a first adsorbent bed unit 704 and a second adsorbent bed unit 706, while the resulting product stream is conducted away from the first adsorbent bed unit 704 and the second adsorbent bed unit 706 via a product conduit 714. A purge stream is passed through a purge conduit 716 to the third adsorbent bed unit 708, while the resulting purge product stream is conducted away from the third adsorbent bed unit 708 via a purge product conduit 718. The purge product stream is passed from the purge product stream to a compressor 724 and then to a heating unit 726 to create a heating stream and then is passed through a heating conduit 720 to the fourth adsorbent bed unit 710, while the resulting heating product stream is conducted away from the fourth adsorbent bed unit 710 via a heating purge product conduit 722 to a purge vent. In addition, the blow-down product stream is conducted away from the fifth adsorbent bed unit 712 via the heating purge product conduit 722 to the purge vent.

In this configuration, the process gas is looped around to provide the necessary heat to facilitate regeneration, while a cleaning purge is used to remove the contaminants from a spent absorbent bed units. The loop is circulated with a compressor 724, which may be a small low-head compressor, such as molecular sieve blower, and heat is supplied by a heating unit 726, both of which may be added to the swing adsorption process skid as add-ons. This configuration may process 2×Mscfd of gas in the adsorption step. As the CO₂ content in the feed stream increases, the purge pressure may be lowered to sufficiently regenerate the adsorbent bed unit. In one example, this configuration may process up to 1% of CO₂, with the purge pressure varying from about 60 bar to about 5 bar.

FIG. 8 is an exemplary diagram 800 of an embodiment of a fifth standardized swing adsorption process skid in accordance with an embodiment of the present techniques. This configuration may be used for high amounts of CO₂ in the feed stream. The standardized swing adsorption process skid 800 may include five adsorbent bed units 804, 806, 808, 810 and 812. The first adsorbent bed unit 804 is performing an adsorption step, while the second adsorbent bed unit 806 is performing a cleaning purge step, the third adsorbent bed unit 808 and fourth adsorbent bed unit 810 is performing a purge heating step and a heating step, respectively, and a fifth adsorbent bed unit 812 is performing a blow-down step. The feed stream is passed through a feed conduit 802 to a first adsorbent bed unit 804, while the resulting product stream is conducted away from the first adsorbent bed unit 804 via a product conduit 814. A purge stream is passed through a purge conduit 816 to the second adsorbent bed unit 806, while the resulting purge product stream is conducted away from the second adsorbent bed unit 806 via a purge product conduit 818. The purge product stream is passed from the purge product conduit 818 to a compressor 824 and then to a heating unit 826 to create a heating stream and then is passed through a heating conduit 820 to the third adsorbent bed unit 808 and the fourth adsorbent bed unit 810, while the resulting heating product stream is conducted away from the third adsorbent bed unit 808 and the fourth adsorbent bed unit 810 via a heating purge product conduit 822 to a purge vent or to the purge product conduit 818. In addition, the blow-down product stream is conducted away from the fifth adsorbent bed unit 812 via the heating purge product conduit 822 to the heating purge vent.

As the CO₂ content in the feed stream further increases, a single adsorbent bed unit is performing an adsorption step, while two adsorbent bed units are on the loop being heated. The loop is circulated with a compressor 824, which may be a larger low-head compressor, such as molecular sieve blower, and heat is supplied by a heating unit 826, both of which may be designed as adjustments to the standardized swing adsorption process skid as add-ons. This configuration can process X Mscfd of gas in the feed. As the CO₂ content in the feed increases, the purge pressure can be lowered to sufficiently regenerate the bed. In one example, this configuration may process up to 2% of CO₂, with the purge pressure varying from about 60 bar to about 5 bar.

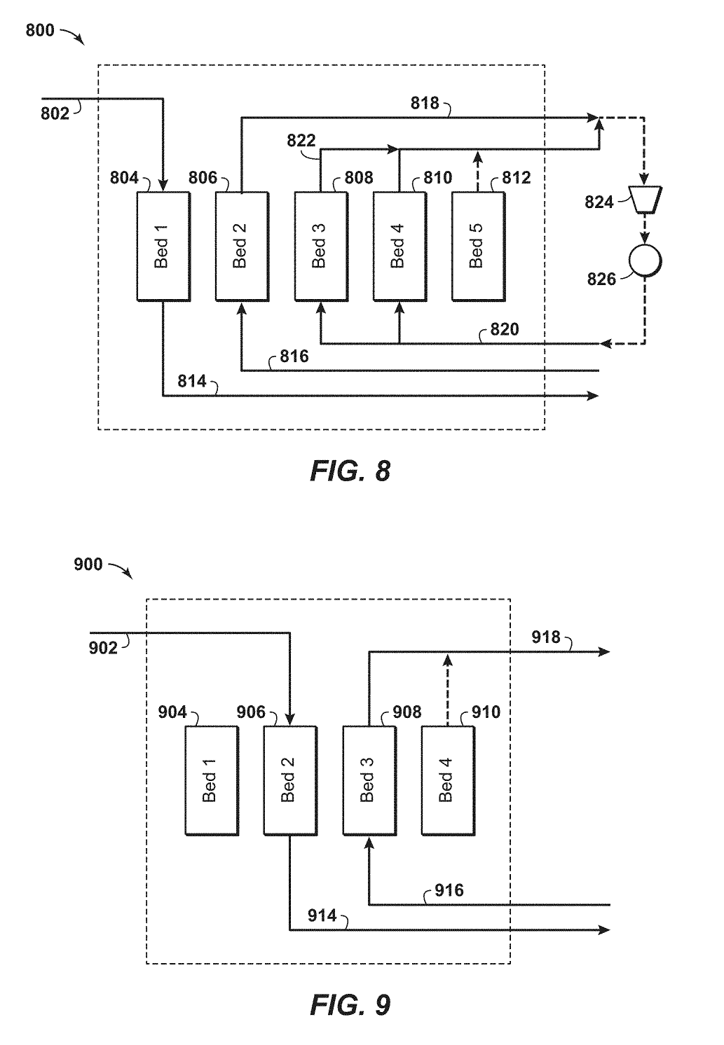

FIG. 9 is an exemplary diagram 900 of an embodiment of a sixth standardized swing adsorption process skid in accordance with an embodiment of the present techniques. The standardized swing adsorption process skid 900 may include four adsorbent bed units 904, 906, 908 and 910 and may be used for dehydration upstream of cryogenic NGL recovery. The second adsorbent bed unit 906 is performing an adsorption step, while the third adsorbent bed unit 908 is performing a purge step and a fourth adsorbent bed unit 910 is performing a blow-down step. Here, the first adsorbent bed unit 904 may be utilized as a spare or a standby unit. The feed stream is passed through a feed conduit 902 to the second adsorbent bed unit 906, and the resulting product stream is conducted away from the second adsorbent bed unit 906 via a product conduit 914. A purge stream is passed through a purge conduit 916 to the third adsorbent bed unit 908, while the resulting purge product stream is conducted away from the third adsorbent bed unit 908 via a purge product conduit 918 to a purge vent. A blow-down product stream is conducted away from the fourth adsorbent bed unit 910 via the heating purge product conduit 918 to the purge vent.

For dehydration applications, the amount of contaminant to be removed may be capped by the saturation conditions of the gas in the feed stream. As such, a set of cycle configuration may not be necessary. In this configuration, the standard swing adsorption process skid may have a spare adsorbent bed unit installed, which may be in standby mode. However, if additional through put is needed, the spare adsorbent bed unit may be brought into operation.

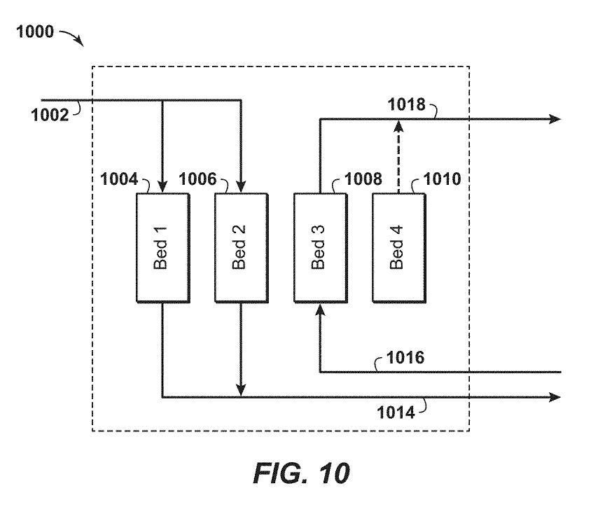

FIG. 10 is an exemplary diagram 1000 of an embodiment of a seventh standardized swing adsorption process skid in accordance with an embodiment of the present techniques. The standardized swing adsorption process skid 1000 may include four adsorbent bed units 1004, 1006, 1008 and 1010 and may be used for LNG dehydration. The first adsorbent bed unit 1004 and second adsorbent bed unit 1006 are performing an adsorption step, while the third adsorbent bed unit 1008 is performing a purge step and a fourth adsorbent bed unit 1010 is performing a blow-down step. The feed stream is passed through a feed conduit 1002 to the first adsorbent bed unit 1004 and the second adsorbent bed unit 1006, and the resulting product stream is conducted away from the first adsorbent bed unit 1004 and the second adsorbent bed unit 1006 via a product conduit 1014. A purge stream is passed through a purge conduit 1016 to the third adsorbent bed unit 1008, while the resulting purge product stream is conducted away from the third adsorbent bed unit 1008 via a purge product conduit 1018 to a purge vent. A blow-down product stream is conducted away from the fourth adsorbent bed unit 1010 via the heating purge product conduit 1018 to the purge vent.

For dehydration applications, the amount of contaminant to be removed is capped by the saturation conditions of the gas in the feed stream. As such, such an elaborate set of cycle configuration is not necessary. In this configuration, the spare adsorbent bed may be brought into operation.

In one or more embodiments, when using RCTSA or an integrated RCPSA and RCTSA process, the total cycle times are typically less than 600 seconds, preferably less than 400 seconds, preferably less than 300 seconds, preferably less than 250 seconds, preferably less than 180 seconds, more preferably less than 90 seconds, and even more preferably less than 60 seconds. In other embodiment, the rapid cycle configuration may be operated at lower flow rates during startup mode as compared to normal operation mode, which may result in the cycle durations being longer than the cycle durations during normal operation mode. For example, the cycle duration may be extended to 1,000 seconds for some cycles.

In view of the many possible embodiments to which the principles of the disclosed invention may be applied, it should be recognized that the illustrative embodiments are only preferred examples of the invention and should not be taken as limiting the scope of the invention.

What is claimed is:

1. A process for removing contaminants from a gaseous feed stream with a swing adsorption process, the process comprising:
a) obtaining a standardized swing adsorption process skid;
b) obtaining hydrocarbon processing data associated with a hydrocarbon processing application associated with a swing adsorption process;
c) determining adjustments to the standardized swing adsorption process skid;
d) configuring the standardized swing adsorption process skid based on the adjustments to obtain an adjusted standardized swing adsorption process skid; and
e) processing a gaseous feed stream to remove contaminants from the gaseous feed stream to produce a product stream with the adjusted standardized swing adsorption process skid using the swing adsorption process.

2. The process of claim 1, further comprising deploying the adjusted standardized swing adsorption process skid to a location to perform the swing adsorption process on the gaseous feed stream.

3. The process of claim 1, further comprising deploying the standardized swing adsorption process skid to a location; and configuring the standardized swing adsorption process skid at the location.

4. The process of claim 1, further comprising:
wherein step b) comprises monitoring the product stream of the swing adsorption process, and passing the product stream to a downstream process if the product stream is within specification; and
wherein step d) comprises configuring the swing adsorption process skid to obtain the adjusted standardized swing adsorption process skid if the product stream is not within specification.

5. The process of claim 4, wherein the downstream process is a liquefied natural gas (LNG) process that comprises an LNG process unit.

6. The process of claim 1, wherein the standardized swing adsorption process skid comprises two or more swing adsorption bed units and a plurality of valves in each of the two or more swing adsorption bed units.

7. The process of claim 6, wherein the determining adjustments to the standardized swing adsorption process skid comprises determining at least one adsorbent material for an adsorbent bed to be disposed within each of the two or more swing adsorption bed units.

8. The process of claim 1, wherein the standardized swing adsorption process skid comprises two or more swing adsorption bed units, and wherein the determining adjustments to the standardized swing adsorption process skid comprises determining at least one adsorbent material for an adsorbent bed to be disposed within at least one swing adsorption bed unit.

9. The process of claim 6, wherein configuring the standardized swing adsorption process skid comprises adjusting flow paths for one or more conduits coupled to each of the two or more swing adsorption bed units.

10. The process of claim 7, wherein configuring the standardized swing adsorption process skid comprises adjusting flow paths for one or more conduits coupled to each of the two or more swing adsorption bed units.

11. The process of claim 1, wherein the swing adsorption process comprises:
a) performing an adsorption step, wherein the adsorption step comprises passing the gaseous feed stream through an adsorbent bed unit to remove the contaminants and produce the product stream;
b) interrupting the flow of the gaseous feed stream;
c) performing a regeneration step, wherein the regeneration step comprises removing one or more of the contaminants from the adsorbent bed unit; and
d) repeating the steps a) to c) for at least one additional cycle in the swing adsorption process.

12. The process of claim 11, wherein the regeneration step comprises:
performing a heating step, wherein the heating step comprises passing a heating stream through the adsorbent bed unit to remove one or more of the contaminants from the adsorbent bed unit;
performing a cooling step, wherein the cooling step comprises lessening the temperature of an adsorbent material in the adsorbent bed unit by passing a cooling stream through the adsorbent bed unit.

13. The process of claim 1, wherein the swing adsorption process has a cycle duration is for a period greater than 1 second and less than 600 seconds.

14. The process of claim 12, wherein the swing adsorption process has a cycle duration is for a period greater than 1 second and less than 600 seconds.

15. The process of claim 14, wherein the gaseous feed stream is a hydrocarbon containing stream having greater than one volume percent hydrocarbons based on the total volume of the gaseous feed stream.

16. The process of claim 15, wherein the gaseous feed stream comprises hydrocarbons and CO₂, wherein the CO₂ content is in the range of two hundred parts per million volume and less than or equal to about 2% volume of the gaseous feed stream.

17. The process of claim 16, wherein the swing adsorption process is configured to lower the carbon dioxide (CO₂) level to less than 50 parts per million.

18. The process of claim 17, wherein the swing adsorption process has a cycle duration that is greater than 2 seconds and less than 180 seconds.

19. The process of claim 18, wherein the swing adsorption process is a pressure swing adsorption process.

20. The process of claim 1, wherein the standardized swing adsorption process skid comprises four or more swing adsorption bed units and a plurality of valves in each of the four or more swing adsorption bed units.
